(19) United States
(12) Patent Application Publication
(10) Pub. No.: US 2017/0364807 A1
(43) Pub. Date: Dec. 21, 2017

(54) IDENTIFICATION OF APPLICATION MESSAGE TYPES

(71) Applicant: ENTIT SOFTWARE LLC, Sunnyvale, CA (US)

(72) Inventors: Amichai Nitsan, Yehud (IL); Eva Margulis Dimov, Yehud (IL); Shalom Kramer, Yehud (IL); Efrat Egozi Levi, Yehud (IL)

(21) Appl. No.: 15/535,615

(22) PCT Filed: Dec. 22, 2014
(86) PCT No.: PCT/US2014/071834

§ 371 Date: Jun. 13, 2017

(51) Int. Cl. G06N 5/02; G06F 9/54; G06N 99/00; G06F 11/07

(52) U.S. Cl. CPC G06N 5/022; G06N 99/005; G06F 9/546; G06F 11/0721; G06F 11/0769

(57) ABSTRACT

In one example of the disclosure, a subject message for a display caused by a subject software application is obtained. A prediction model is utilized to identify the subject message as a first type message or a second type message. The model is a model determined based upon a set of target words determined by imposition of a set of rules upon a set of user facing messages extracted from a set of software applications, wherein each of the extracted messages was classified post-extraction as a first type message or a second type message. A communication identifying the subject message as the first type message or the second type message is provided.

### BACKGROUND

Many services are delivered to consumers via software applications. In examples, these software applications may be composite in that several software components work in combination to fulfill the service. The components themselves may be distributed across various physical and virtual devices. For instance, a smartphone, tablet, notebook or other user computing device may serve as a client side user interface component. Through that user interface component, a user may initiate a series of actions carried to be carried out by the user computing device and by server side components to fulfill the service.

### DRAWINGS

FIG. 1 is a block diagram depicting an example environment in which various examples of identification of application message types may be implemented.

FIGS. 2A and 2B are block diagrams depicting examples of a system enabling identification of application message types.

FIGS. 3A and 3B are block diagrams depicting a memory resource and a processing resource to implement examples of enabling identification of application message types.

FIG. 4 illustrates an example of enabling identification of application message types.

FIG. 5 is a flow diagram depicting steps taken to implement an example of identification of application message types utilizing a prediction model.

FIG. 6 is a flow diagram depicting steps taken to implement an example of determining a prediction model for identifying application message types.

### DETAILED DESCRIPTION

Introduction:

For a provider of a software application, understanding the user experience and users satisfaction with the application are key factors to successful implementation. With such an understanding, the provider of the application can better evaluate the success or likely success of the software application and how to invest resources for future development. An important issue in evaluating user experience and satisfaction can be identifying failed user interactions with the application. In some situations failed user interactions will result in a crash of the application and/or device the user is interacting with, and are therefore readily identifiable. In many cases, though, a failed user interaction with the application merely causes an error message at the device (e.g., an error message displayed in a popup or other graphic user interface element) without an application or device crash.

Typically error detection in monitoring and testing environments has been accomplished by analyzing log messages for the subject application, e.g., spotting errors in the log according to predefined templates. However, errors found in logs do not always represent the actual error a user experienced. This can be because the log errors may reflect a problem in the code flow versus the user's usage flow. Further, detecting failed user interactions via error statements outside of code error logs has been challenging in that error messages displayed in popups and similar graphic user interface elements will often appear identical to non-error messages except for the text. For instance, the text may not always include “error” or another easily recognized trigger word.

To address these issues, various examples described in more detail below provide a system and a method to identify application message types utilizing a prediction model, wherein the prediction model is determined via imposition of a set of rules upon a set of user facing messages extracted from a set of software applications. In one example of the disclosure, a subject message is obtained by an application message type identification system. The subject message is a message that is to be part of a display caused by a subject software application. A prediction model is utilized to identify the subject message as a first type message or a second type message (e.g., an error message type versus non-error message type). The prediction model is a model determined based upon a set of target words determined by imposition of a set of rules upon a set of user facing messages extracted from a set of software applications, wherein each of the extracted messages was classified post-extraction as a first type message or a second type message. In turn, a communication identifying the subject message as the first type message or the second type message is provided.

In other various examples described in more detail below, a system and a method are provided to determine a prediction model to be utilized to identify application message types. In an example of the disclosure, a set of user-facing messages extracted from a set of software applications is accessed. Each of the extracted messages is a message that has been classified after extraction as a first type message or a second type message (e.g., an error type or non-error type message). Rules are applied to the accessed messages to create a set of target words. For each of the target words, a message distribution of the target word across a message is calculated, and a set distribution of the target word across the set of messages is calculated. A machine learning algorithm is in turn applied to determine a message type prediction model that is based upon the calculated message distributions and set distributions.

It should be noted that while the disclosure is discussed frequently with reference to examples wherein a prediction model is utilized to identify a subject message as a first type message or a second type message, the first type message being an error message and the second type message being a non-error message, teachings of the present disclosure are not so limited and can be applied to any first and second message types. For instance, in examples of the disclosure, a prediction model may be determined and utilized to identify a subject message as a first type message or a second type message, wherein the first message type is an understandable message, and the second type message is a non-understandable message. Other choices for the first and second message types are possible and are contemplated by this disclosure.

In this manner, examples described herein can enable providers of software applications to, in an automated and efficient manner, identify first and second type messages (e.g., error messages and non-error messages, or understandable and non-understandable messages, or other combinations of first and second type messages). Disclosed examples will enable application providers to regularly update the prediction model with new data as the set of extracted and analyzed messages is expanded, and can be can be integrated into other software testing products. Thus, application providers' and developers' satisfaction with products and services that evaluate software application performance utilizing the disclosed examples, and the physical and virtual devices that host or otherwise facilitate such software application evaluation services, should increase. Further end user satisfaction with the subject software applications that are evaluated utilizing the derived prediction model, and the physical and virtual devices that are used to access or host such subject software applications, should increase.

The following description is broken into sections. The first, labeled “Environment,” describes an environment in which various examples may be implemented. The second section, labeled “Components,” describes examples of various physical and logical components for implementing various examples. The third section, labeled “Illustrative Example,” presents an example of identification of application message types. The fourth section, labeled “Operation,” describes steps taken to implement various examples.

Environment:

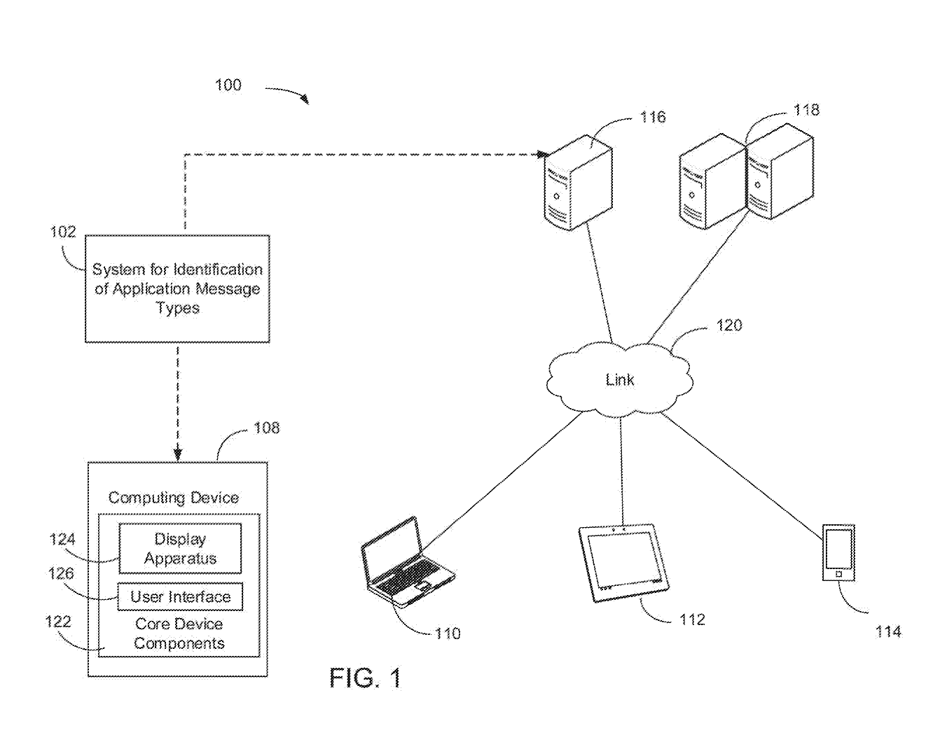

FIG. 1 depicts an example environment 100 in which examples may be implemented as a system 102 for identification of application message types. Environment 100 is shown to include computing device 108, client devices 110, 112, and 114, server device 116, and server devices 118. Components 108-118 are interconnected via link 120.

Link 120 represents generally any infrastructure or combination of infrastructures to enable an electronic connection, wireless connection, other connection, or combination thereof, to enable data communication between components 108-118. Such infrastructure or infrastructures may include, but are not limited to, one or more of a cable, wireless, fiber optic, or remote connections via telecommunication link, an infrared link, or a radio frequency link. For example, link 120 may represent the internet, one or more intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 110, 112, and 114 represent generally any computing device with which a user may interact to communicate with other client devices, server device 116, and/or server devices 118 via link 120. Server device 116 represents generally any computing device to serve an application and corresponding data for consumption by components 108-118. Server devices 118 represent generally a group of computing devices collectively to serve an application and corresponding data for consumption by components 108-118.

Computing device 108 represents generally any computing device with which a user may interact to communicate with client devices 110-114, server device 116, and/or server devices 118 via link 120. Computing device 108 is shown to include core device components 122. Core device components 122 represent generally the hardware and programming for providing the computing functions for which device 108 is designed. Such hardware can include a processor and memory, a display apparatus 124, and a user interface 126. The programming can include an operating system and applications. Display apparatus 124 represents generally any combination of hardware and programming to exhibit or present a message, image, view, or other presentation for perception by a user, and can include, but is not limited to, a visual, tactile or auditory display. In examples, the display apparatus 124 may be or include a monitor, a touchscreen, a projection device, a touch/sensory display device, or a speaker. User interface 126 represents generally any combination of hardware and programming to enable interaction between a user and device 108 such that the user may effect operation or control of device 108. In examples, user interface 126 may be, or include, a keyboard, keypad, or a mouse. In some examples, the functionality of display apparatus 124 and user interface 126 may be combined, as in the case of a touchscreen apparatus that may enable presentation of images at device 108, and that also may enable a user to operate or control functionality of device 108.

System 102, discussed in more detail below, represents generally a combination of hardware and programming to enable identification of application message types. In some examples, system 102 may be wholly integrated within core device components 122. In other examples, system 102 may be implemented as a component of any of computing device 108, client devices 110-114, server device 116, or server devices 118 where it may take action based in part on data received from core device components 122 via link 120.

In other examples, system 102 may be distributed across computing device 108, and any of client devices 110-114, server device 116, or server devices 118. For instance, in an example system 102 may include a model component that operates on server device 116 (or one or more other devices shown or not shown in FIG. 1) and an identification component that operates on server devices 118 (or one or more other devices not shown in FIG. 1). In this example of a distributed model, the model component may be responsible for determining a prediction model based upon the calculated message distributions and set distributions, and the identification component may be responsible for utilizing the prediction model to identify the subject message as a first type message or a second type message (e.g., an error type message and a non-error type message, or an understandable type message and a non-understandable type message).

In a particular example, message engine 202, identification engine 204, and communication engine 206 may be included in a message type identification computer system 102 hosted at computing device 108, wherein the accessed subject message is a message for display when the subject software application is executed at a client computer system, e.g., a mobile client device 114. In this particular example, the communication may be provided to a developer computer system, e.g., at server 116, that will utilize the communication to determine a user experience rating for the application.

Components:

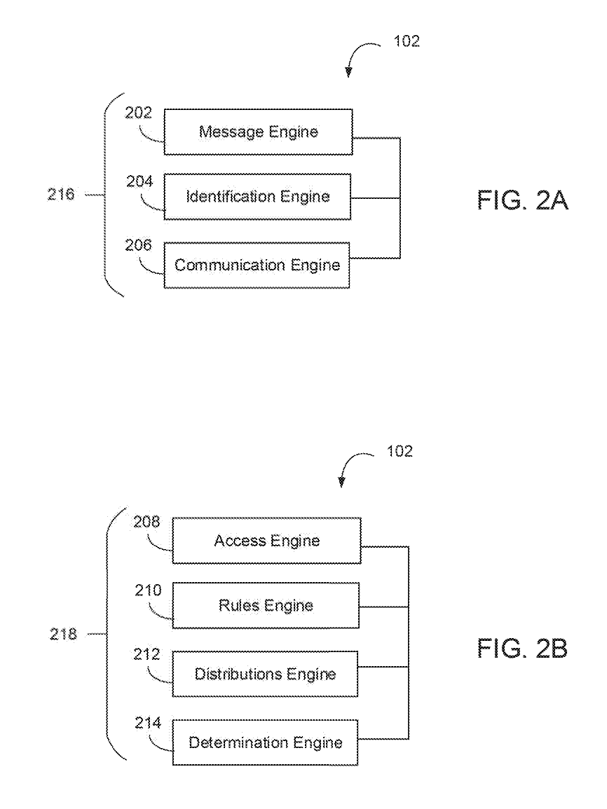

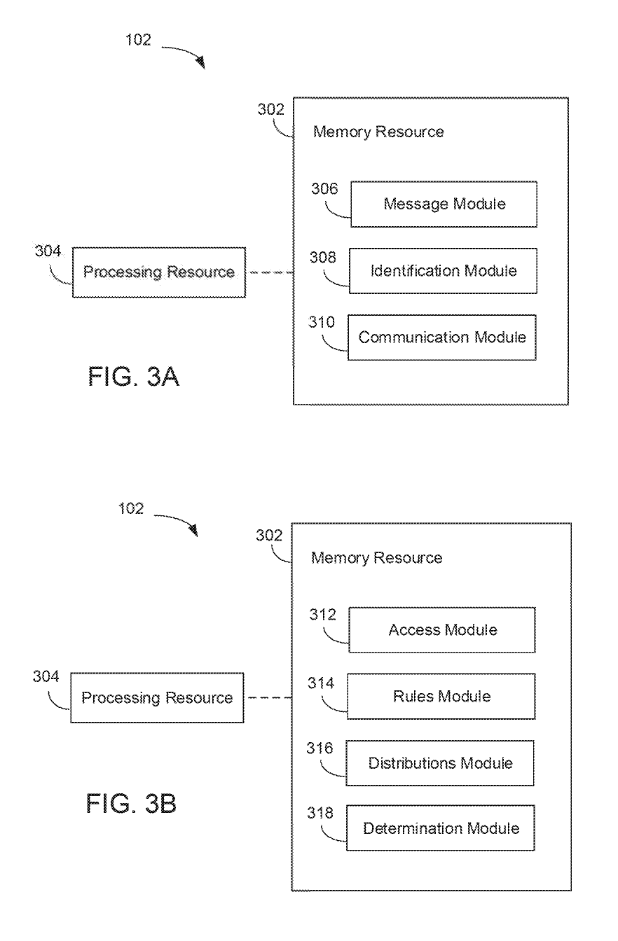

FIGS. 2A, 2B, 3A, and 3B depict examples of physical and logical components for implementing various examples. In FIGS. 2A and 2B various components are identified as engines 202, 204, 206, 208, 210, 212, and 214. In describing engines 202, 204, 206, 208, 210, 212, and 214 focus is on each engine's designated function. However, the term engine, as used herein, refers generally to a combination of hardware and programming to perform a designated function. As is illustrated later with respect to FIGS. 3A and 3B the hardware of each engine, for example, may include one or both of a processor and a memory, while the programming may be code stored on that memory and executable by the processor to perform the designated function.

FIG. 2A is a block diagram depicting components of a system 102 to enable identification of application message types utilizing a prediction model. In this example, system 102 includes message engine 202, identification engine 204, and communication engine 206. In performing their respective functions, engines 202, 204, and 206 may access a data repository, e.g., any memory accessible to system 102 that can be used to store and retrieve data.

In an example, message engine 202 represents generally a combination of hardware and programming to obtain a subject message, the subject message for a display caused by a subject software application. As used herein, a “message” refers generally to any communication, and is not meant to be limited to text or a character string. As used herein, “display” refers generally to an exhibition or presentation caused by a computer for the purpose of perception by a user. In an example, a display may be or include a GUI display to be presented at a computer monitor, touchscreen, or other electronic display device. As used herein, “software application” and “application” are used synonymously, and refer generally to a web application, mobile application, software application, firmware application, or other programming that executes at, or is accessible at, a computing device.

Continuing with FIG. 2A, identification engine 204 represents generally a combination of hardware and programming to utilize a prediction model to identify the subject message that was obtained by message engine 202 as a first type message or a second type message, in one particular example, identification engine 204 is to utilize the model to identify the subject message as one of an error message or a non-error message. In another particular example, identification engine 204 is to utilize the model to identify the subject message as one of an understandable message or a non-understandable message.

The model that is utilized by identification engine 204 to identify the obtained subject message as a first or second type message is a model determined based upon a set of target words. The target words set is a set of words that was determined by imposition of a set of rules upon a set of user facing messages extracted from a set of software applications, wherein each of the extracted messages was classified post-extraction as a first type message or a second type message. In an example, the set of extracted messages is a set of messages that were presented to one or more users for manual classification as a first type versus second type message (e.g., an error message versus a non-error message, or as an understandable versus non-understandable message). In an example, the set of classified software applications that were user-classified by a user post-extraction is a set of applications that does not include the subject application. In an example, the set of extracted messages is a set of messages that were extracted from the set of software applications via execution of a script or scripts that interacted with software applications in the set. As used herein, a “script” refers generally to any computer programs, including, but not limited to, small programs (e.g., up to a few thousand lines of code) and/or programs written in domain-specific languages.

Continuing with FIG. 2A, in one example of the disclosure the prediction model that is utilized by identification engine 204 to identify the obtained subject message as a first or second type message is a model determined based upon calculated message distributions and calculated set distributions for each of the set of target words. As used herein, a “calculated message distribution” refers generally to a calculation of distribution of a target word within a user facing message from the set of user facing messages. In an example, the calculation of occurrences of the target word within the user facing message is a count of occurrences within the message. As used herein, a “calculated set distribution” refers generally to a calculation of distribution of a target word across the set of user facing messages. In an example, the calculation of occurrences of the target word across the set of user facing messages is a count of occurrences within the set of messages.

In an example of the disclosure, the prediction model utilized to identify the subject message as a first or second type message is a model determined according to a process that included the imposition of a set of rules imposed upon the extracted user facing messages, the rules including stemming words in the extracted messages to root representations of the words. In an example of stemming, the words “recovery”, “recoverable”, and “recovered” might be stemmed to a “recover” root representation of the words.

In an example, the prediction model is a model determined according to a process that included a rule of removing stop words from extracted messages. As used herein, a “stop word” refers generally to a specific word, or specific phrase, which is to be filtered out due to being not helpful in differentiating first and second type messages. In different situations, any group of words can be chosen as the stop words for a given purpose. In an example, stop words may include common, short function words, such as “the”, “is”, “at”, “which”, and so on.

Continuing with FIG. 2A, in an example the prediction model is a model determined according to a process that included a rule of normalizing the calculated message distributions and/or calculated set distributions. As used herein, “normalizing” the calculated message and/or calculated set distributions refers generally to adjusting values of the calculated distributions to a common or preferred scale. In an example, message distributions and set distributions may have been calculated within a range that was deemed too small for the example (e.g., a range between “0” and “0.3”) or that was deemed too large for the example (e.g., a range between “1” and “7”), and in turn the message and set distributions may be normalized to fall within a desired scale for the example ranging between “0” and “1.”

In an example, the prediction model is a model determined according to a process that included imposing a rule wherein, for each of the extracted user facing messages, a bag of words was created to represent the extracted message as a vector of the target words included within the message. As used herein, a “bag of words” refers generally to any a simplifying representation wherein text (e.g., an extracted message) is represented as a collection or vector of its words. In an example, the bag of words may be a representation or vector of an extracted message that disregards grammar and word order of the message as extracted. In an example, the bag of words may be a representation or vector of an extracted message that disregards grammar and word order of the message as extracted, yet maintains multiplicity.

Continuing with FIG. 2A, in an example the prediction model is a model determined utilizing a machine learning algorithm. As used herein, a “machine learning algorithm” refers generally any to any procedure, formula, function, or algorithm that can solve a problem by learning from data. In examples, machine learning algorithms may operate by building a model based on data inputs and using the model to make predictions or decisions (versus making the predictions or decisions based only on explicitly programmed instructions). Examples of machine learning algorithms include, but are not limited to, probabilistic classifiers such as Naïve Bayes models and logistic regression models. In a particular example, the prediction model is a model determined utilizing a Complement Naïve Bayes probabilistic algorithm, wherein application of the resulting model produces two probabilities: a probability for the extracted message to be a first type message (e.g., an error message or an understandable message) if the message contains a specific attribute or word, and also a probability that the extracted message that contains the attribute or word is of the second type (e.g., a non-error message or a non-understandable message).

In a particular example, identification engine 204 in utilizing the prediction model to identify the subject message as a first type message or a second type message may include one or more of steps of stemming words of the subject message, removing stop words from the subject message, and creating a bag of words for the subject message. In an example, identification engine 204 may, for words in the subject message, apply the determined prediction model to the words to determine the probabilities that the message is a first type message (e.g., an error message) and that the message is a second type message (e.g., a non-error message). In an example, identification engine 204 will classify the subject message as the first type message if the calculated probability that the message is a first type message is greater than the calculated probability that the message is a second type message (e.g., a probability the subject message is not a first type message).

Continuing with FIG. 2A, communication engine 206 represents generally a combination of hardware and programming to provide a communication that identifies the subject message as the first type message or the second type message. In examples, communication engine 206 may provide the communication as a display for a user or users, e.g., a dashboard display or other display caused by system 102. In examples, system may include a combination of hardware and programming (e.g., a monitor or touchscreen and graphics programming) to effect the display. In other examples, communication engine 206 may provide the communication as a display for a user or users, e.g., a dashboard display or other display wherein the display is to be provided by an application performance evaluation application that is distinct from system 102 and that receives the communication from system 102.

In particular examples, the communication provided by communication engine 206 is to be utilized to determine a user experience rating for the application. As used herein, a “user experience rating” refers generally to rating of user behaviors, attitudes, and/or emotions with respect to use of a product, system or service, e.g., use of the subject application. In examples, a user experience rating may include user perceptions of system aspects such as utility, ease of use and efficiency. In one example, communication engine 102 may determine the user experience rating utilizing the communication, and provide the user experience rating for the application for display to a user. In another example, communication engine 102 may send the communication to a distinct application performance evaluation application, such that the application performance evaluation application can determine a user experiencer rating for the application utilizing the communication and create the display with the user experience rating for user viewing.

In certain examples of the disclosure, message engine 202 may obtain via a network, e.g., link 120 (FIG. 1), a subject message that is in the form in which it will appear when the subject application causes a message display for user perception. An example of such a subject message is “Transaction Failed—Out of Memory” when “Transaction Failed—Out of Memory” is what will be displayed to a user upon occurrence of a failed user action. In other examples of the disclosure, message engine 202 may obtain via the network a subject message that is a template message representative of a set of similar messages for displays caused by the subject application. In this manner, identification engine 204 can utilize the prediction model to identify the obtained subject message as a first type message or a second type message without accessing user personally identifiable information that would have been present in the subject message as displayed in production. In examples, message engine 202 may obtain the template message via execution of a script to scan resource files of the subject application.

FIG. 2B is a block diagram depicting components of a system 102 to enable identification of application message types by determining a prediction model for the identification. In this example, system 102 includes access engine 208, rules engine 210, distributions engine 212, and determination engine 214. In performing their respective functions, engines 208, 210, 212, and 214 may access a data repository.

In an example, access engine 208 represents generally a combination of hardware and programming to access a set of user-facing messages extracted from a set of software applications. Each of the extracted messages is a message that was classified after extraction, e.g., via a user assigning a classification on a message by message basis, as a first type message or a second type message. In one example the first type message may be an error type message and the second type message may be a non-error type message. In another example, the first type message may be an understandable message and the second type message may be a non-understandable message.

Continuing with FIG. 2D, rules engine 210 represents generally a combination of hardware and programming to apply rules to the accessed messages to create a set of target words. In an example, application of the set of rules may include applying a rule to stem words in the extracted messages to root representations of the words, applying a rule to remove stop words from extracted messages, and/or applying a rule to normalize the calculated message distributions and/or calculated set distributions. In a particular example, a rule may applied wherein, for each of the extracted user facing messages, a bag of words is created to represent the extracted message as a vector of the target words included within the message.

Continuing with FIG. 2B, distributions engine 212 represents generally a combination of hardware and programming to, for each of the target words, calculate a message distribution of the target word across a message, and calculate a set distribution of the target word across the set of messages. In examples, the calculation of occurrences of the target word within a user facing message and the calculation of occurrences of the target word across the set are counts of occurrences of the target word within each message and the set.

Continuing at FIG. 2B, determination engine 214 represents generally a combination of hardware and programming to apply a probabilistic classifier to determine a message type prediction model based upon the calculated message distributions and set distributions. In an examples, the probabilistic classifier may be a probabilistic algorithm according to one of the Naïve Bayes models or logistic regression models.

In an example, the determined prediction model is to, when implemented, provide an output of two probabilities: a probability for subject message to be a first type message (e.g., an error message or an understandable message) if the subject message contains a specific attribute or word, and also a probability that the subject message that contains the attribute or word is of the second type (e.g., a non-error message or a non-understandable message). In a particular example, identification engine 204 (FIG. 2A) will classify the subject message as the first type message if the calculated probability that the message is a first type message is greater than the calculated probability that the message is a second type message (e.g., a probability the subject message is not a first type message).

With reference back to FIG. 1 in view of FIGS. 2A and 2B, in one example system 102 may include a model component 218 that includes engines 208-214 operating on server device 116 (or one or more other devices shown or not shown in FIG. 1) and/or an identification component 216 that includes engines 202-206 operating on server devices 118 (or one or more other devices not shown in FIG. 1). In other examples, system 102 may include engines 202-206 and/or engines 208-214 included within, or distributed across, any one or several of client devices 110-114, server device 116, or server devices 118.

In the foregoing discussion of FIGS. 2A and 2B, engines 202-214 were described as combinations of hardware and programming. Engines 202-214 may be implemented in a number of fashions. Looking at FIGS. 3A and 3B the programming may be processor executable instructions stored on a tangible memory resource 302 and the hardware may include a processing resource 304 for executing those instructions. Thus memory resource 302 can be said to store program instructions that when executed by processing resource 304 implement system 102 of FIGS. 2A and 2B.

Memory resource 302 represents generally any number of memory components capable of storing instructions that can be executed by processing resource 304. Memory resource 302 is non-transitory in the sense that it does not encompass a transitory signal but instead is made up of more or more memory components to store the relevant instructions. Memory resource 302 may be implemented in a single device or distributed across devices. Likewise, processing resource 304 represents any number of processors capable of executing instructions stored by memory resource 302. Processing resource 304 may be integrated in a single device or distributed across devices. Further, memory resource 302 may be fully or partially integrated in the same device as processing resource 304, or it may be separate but accessible to that device and processing resource 304.

In one example, the program instructions can be part of an installation package that when installed can be executed by processing resource 304 to implement system 102. In this case, memory resource 302 may be a portable medium such as a CD, DVD, or flash drive or a memory maintained by a server from which the installation package can be downloaded and installed. In another example, the program instructions may be part of an application or applications already installed. Here, memory resource 302 can include integrated memory such as a hard drive, solid state drive, or the like.

In FIG. 3A, the executable program instructions stored in memory resource 302 are depicted as message module 306, identification module 308, and communication module 310. Transaction module 306 represents program instructions that when executed by processing resource 304 may perform any of the functionalities described above in relation to message engine 202 of FIG. 2A. Identification module 308 represents program instructions that when executed by processing resource 304 may perform any of the functionalities described above in relation to identification engine 204 of FIG. 2. Communication module 310 represents program instructions that when executed by processing resource 304 may perform any of the functionalities described above in relation to communication engine 206 of FIG. 2.

In FIG. 3B, the executable program instructions stored in memory resource 302 are depicted as access module 306, rules module 308, distributions module 310, and determination module 312. Access module 312 represents program instructions that when executed by processing resource 304 may perform any of the functionalities described above in relation to access engine 208 of FIG. 2B. Rules module 314 represents program instructions that when executed by processing resource 304 may perform any of the functionalities described above in relation to rules engine 210 of FIG. 2B. Distributions module 316 represents program instructions that when executed by processing resource 304 may perform any of the functionalities described above in relation to distributions engine 212 of FIG. 2B. Determination module 318 represents program instructions that when executed by processing resource 304 may perform any of the functionalities described above in relation to determination engine 214 of FIG. 2B.

### Illustrative Example

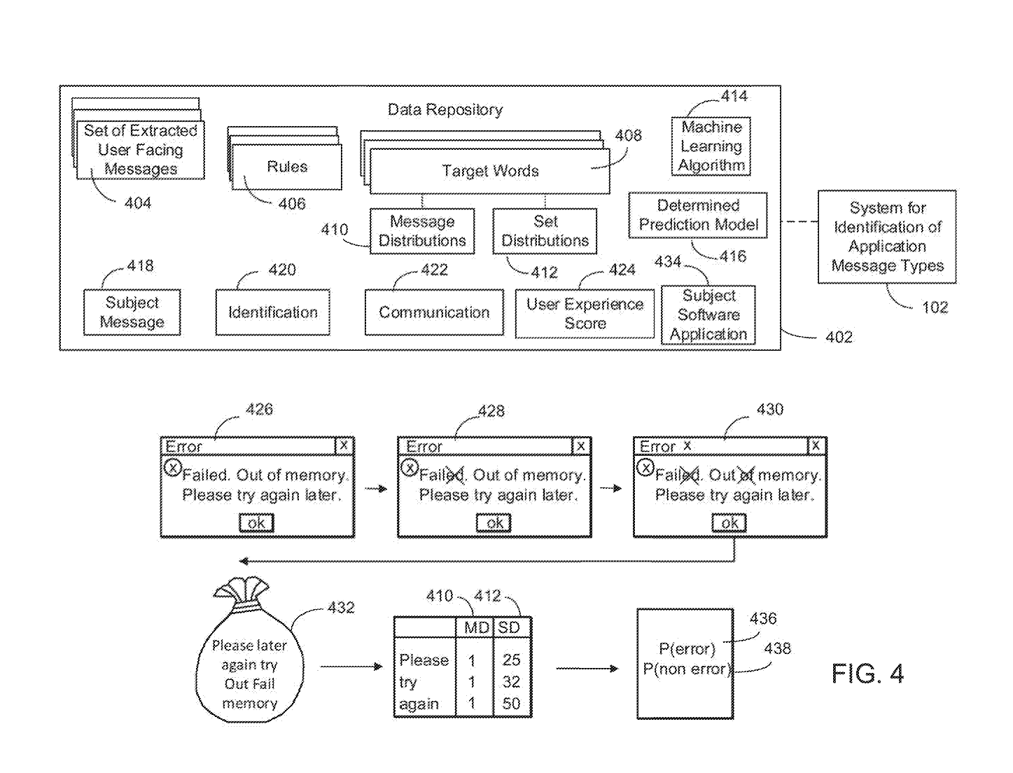

FIG. 4, in view of FIGS. 1, 2A, and 2B, illustrates an example of system 102 enabling evaluation of application performance utilizing user emotional state penalties. In performing its respective functions, system 102 may access one or more data repositories, e.g., data repository 402. Data repository 402 represents generally any memory accessible to system 102 that can be used to store and retrieve data.

In an example, a system 102 accesses a set of user-facing messages 404 extracted from a set of software applications, wherein each of the extracted messages 404 was classified after extraction as an “error message” or a “non-error message.” For instance, system 102 accesses a first extracted message 426 (“Failed. Out of memory. Please try again later.”) that was user-classified as an error message.

System 102 applies rules 406 to the accessed messages to create a set of target words 408. For instance, at 428, system 102 applies a rule to stem the word “Failed” in the first extracted message to its root representation “Fail.” At 430, system 102 applies a rule to remove a stop word “of” from the first extracted message 426.

At 432 system imposes a rule 406 wherein a bag of words 432 is created to represent an extracted message 426 (referred to in this example without limitation as to extraction order as the “first extracted message 426”) as a vector of the target words 408 “Please”, “later”, “again”, “try”, “Out”, “Fail”, and “memory” that are included within the first extracted message 426. In this example the bag of words 432 disregards grammar and word order of the message as extracted.

Continuing at FIG. 4, for each of the target words 408 determined by imposition of the set of rules 406, system 102 calculates a message distribution 410 of the target word across a message, and calculates a set distribution 412 of the target word across the set 404 of extracted user facing messages. For instance, a message distribution 410 and a set distribution 412 are calculated for the target words “Please”, “try”, and “again” from the first extracted message 426. In this instance each of the target words “Please”, “try”, and “again” has a message distribution of “1” with respect to the first extracted message 426 as these words appear once in the first extracted message 426. In this instance the target word “Please” has a set distribution of “25” as it is determined that the target word “Please” occurs 25 times within the set 404 of extracted user facing messages. Similarly, system 102 determines that the target word “try” has a set distribution of “32” and that the target word “again” has a set distribution of “50.”

System 102 in turn applies a machine learning algorithm 414 to determine a message type prediction model 416 based upon the calculated message distributions 410 and set distributions 412 for each of the determined target words 408. In an example, system 102 may apply one of the Naïve Bayes or logistic regression learning models. In this example, the resulting prediction model 416 is a model wherein the model, when utilized to determine whether an obtained subject message is an error message or a non-error message, will return two probabilities: a first probability 436 that the subject message is an error message and a second probability 438 that the subject message is a non-error message.

Continuing at FIG. 4, in a particular example system 102 may obtain a subject message 418 that is a message that is to be displayed by a subject software application 434. Here the subject software application 434 is an application to be evaluated with respect to user experience utilizing identification of error versus non-error messages made possible by system 102. System 102 in turn utilizes the determined prediction model 416 to identify the subject message 418 of the subject software application 434 as an “error message” or a “non-error message”, and provides a communication 422 that includes the identification 420.

In one example, system 102 may provide the communication to a user experience component at system 102, which in turn may determine a user experience score 424 for the subject software application 434 for user display. In another example, system 102 may provide the communication 422 to a computer system separate from system 102. In an example, the separate computer system may in turn determine a user experience score for the subject software application 434.

Operation:

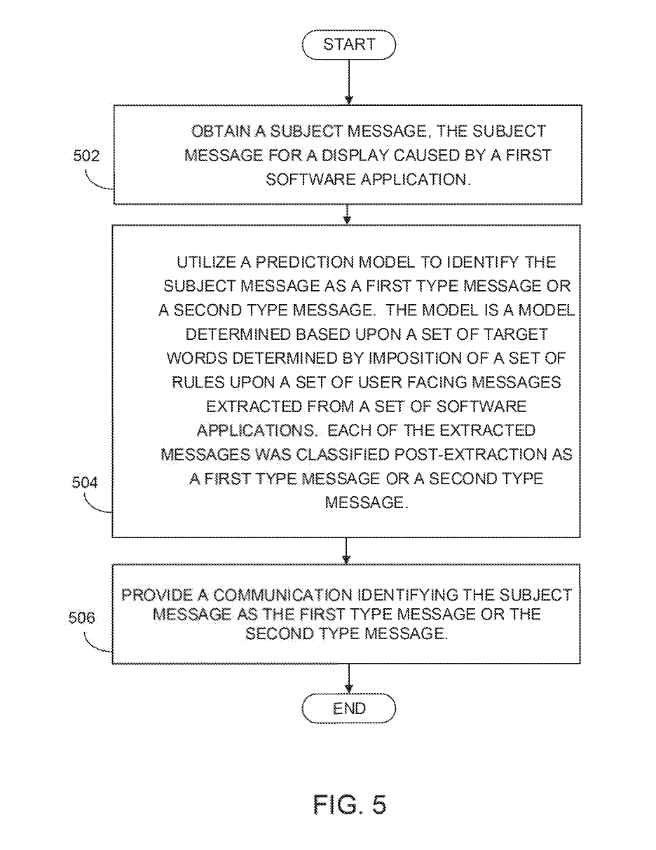

FIG. 5 is a flow diagram of steps taken to implement a method for identifying application message types. In discussing FIG. 5, reference may be made to the components depicted in FIGS. 2A and 3A. Such reference is made to provide contextual examples and not to limit the manner in which the method depicted by FIG. 5 may be implemented. A subject message for a display caused by a subject software application is obtained (block 502). Referring back to FIGS. 2A and 3A, message engine 202 (FIG. 2A) or message module 306 (FIG. 3A), when executed by processing resource 304, may be responsible for implementing block 502.

A prediction model is utilized to identify the subject message as a first type message or a second type message. The prediction model is a model determined based upon a set of target words determined by imposition of a set of rules upon a set of user facing messages extracted from a set of software applications. Each of the extracted messages is a message that was classified post-extraction as a first type message or a second type message (block 504). Referring back to FIGS. 2A and 3A, identification engine 204 (FIG. 2A) or identification module 308 (FIG. 3A), when executed by processing resource 304, may be responsible for implementing block 504.

A communication identifying the subject message as the first type message or the second type message is provided (block 506). Referring back to FIGS. 2A and 3A, communication engine 206 (FIG. 2A) or communication module 310 (FIG. 3A), when executed by processing resource 304, may be responsible for implementing block 506.

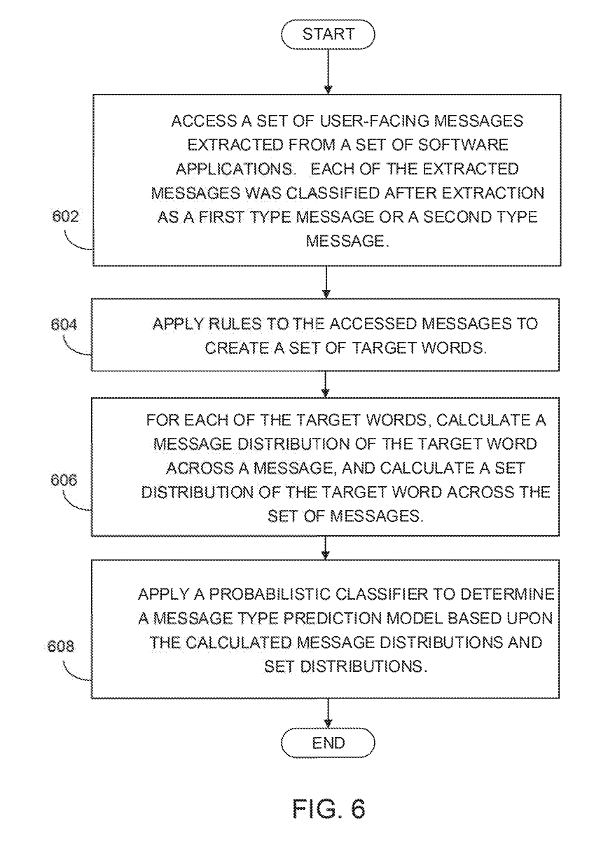

FIG. 6 is a flow diagram of steps taken to implement a method for identification of application message types. In discussing FIG. 6, reference may be made to the components depicted in FIGS. 2B and 3B. Such reference is made to provide contextual examples and not to limit the manner in which the method depicted by FIG. 6 may be implemented. A set of user-facing messages extracted from a set of software applications is accessed. Each of the extracted messages was classified after extraction as a first type message or a second type message (block 602). Referring back to FIGS. 2B and 3B, access engine 208 (FIG. 2B) or access module 312 (FIG. 3B), when executed by processing resource 304, may be responsible for implementing block 602.

Rules are applied to the accessed messages to create a set of target words (block 604). Referring back to FIGS. 2B and 3B, rules engine 210 (FIG. 2B) or rules module 314 (FIG. 3B), when executed by processing resource 304, may be responsible for implementing block 604.

For each of the target words, a message distribution of the target word across a message is calculated, and a set distribution of the target word across the set of messages is calculated (block 606). Referring back to FIGS. 2B and 3B, distributions engine 212 (FIG. 2B) or distributions module 316 (FIG. 3B), when executed by processing resource 304, may be responsible for implementing block 606.

A probabilistic classifier is applied to determine a message type prediction model based upon the calculated message distributions and set distributions (block 608). Referring back to FIGS. 2B and 3B, determination engine 214 (FIG. 2B) or determination module 318 (FIG. 3B), when executed by processing resource 304, may be responsible for implementing block 608.

### CONCLUSION

FIGS. 1-6 aid in depicting the architecture, functionality, and operation of various examples. In particular, FIGS. 1, 2A, 2B, 3A, and 3B depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s). Examples can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 5 and 6 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been shown and described with reference to the foregoing examples. It is to be understood, however, that other forms, details and examples may be made without departing from the spirit and scope of the invention that is defined in the following claims. All of the features disclosed in this specification (including any accompanying claims, abstract and drawings), and/or all of the steps of any method or process so disclosed, may be combined in any combination, except combinations where at least some of such features and/or steps are mutually exclusive.

What is claimed is:

1. A system to identify application message types, comprising:
a message engine, to obtain a subject message, the subject message for a display caused by a subject software application;
an identification engine, to utilize a prediction model to identify the subject message as a first type message or a second type message, wherein the model is a model determined based upon a set of target words determined by imposition of a set of rules upon a set of user facing messages extracted from a set of software applications, wherein each of the extracted messages was classified post-extraction as a first type message or a second type message; and
a communication engine, to provide a communication identifying the subject message as the first type message or the second type message.

2. The system of claim 1, wherein the first type message is an error message, and the second type message is a non-error message.

3. The system of claim 1, wherein the first type message is an understandable message, and the second type message is a non-understandable message.

4. The system of claim 1, wherein the communication is utilized to determine a user experience rating for the application.

5. The system of claim 1, wherein the model is a model based upon calculated message distributions and calculated set distributions for each of the set of target words.

6. The system of claim 5, wherein each calculated message distribution is a count of a target word within a user facing message from the set of user facing messages, and wherein each calculated set distribution is a count of a target word across the set of user facing messages.

7. The system of claim 5, wherein imposition of the set of rules upon the set of user facing messages includes at least one of stemming a word in the message to a root representation, removing stop words, and normalizing the calculated message distributions and calculated set distributions.

8. The system of claim 1, wherein set of user facing messages was extracted via execution of a script or scripts that interacted with the set of software applications.

9. The system of claim 1, wherein the imposition of the set of rules includes, for each of the user facing messages, creating a bag of words that represents the message as a vector of the target words included within the message.

10. The system of claim 5, wherein determination of the prediction model includes utilization of a machine learning algorithm.

11. The system of claim 1, wherein the obtained subject message is a template message representative of a set of similar messages for displays caused by the subject application, such that the identification engine can utilize the prediction model to identify the subject message as a first type message or a second type message without access to user personally identifiable information, and wherein the template message is obtained via execution of a script to scan resource files of the subject application.

12. The system of claim 1, wherein the message engine, the identification engine, and the communication engine are included within an message type identification computer system, wherein the subject message is for display when the subject software application is executed at a client computer system, and wherein the communication is provided to a developer computer system.

13. A memory resource storing instructions that when executed cause a processing resource to determine a prediction model for identifying application message types, the instructions comprising:
an access module that when executed causes the processing resource to access a set of user-facing messages extracted from a set of software applications, wherein each of the extracted messages was classified after extraction as a first type message or a second type message;
a rules module that when executed causes the processing resource to apply rules to the accessed messages to create a set of target words;
a distributions module that when executed causes the processing resource to for each of the target words, calculate a message distribution of the target word across a message, and calculate a set distribution of the target word across the set of messages; and
a determination module that when executed causes the processing resource to apply a probabilistic classifier to determine a message type prediction model based upon the calculated message distributions and set distributions.

14. The memory resource of claim 13, wherein the first type message is an error message and the second type message is a non-error message, or wherein the first type message is an understandable message and the second type message is a non-understandable message.

15. A method to determine and utilize a prediction model for identification of application error messages, comprising:
accessing a set of user-facing messages extracted from a set of software applications, wherein each of the extracted messages was classified after extraction as a first type message or a second type message;
applying rules to the accessed messages to create a set of target words;
for each of the target words, calculating a message distribution of the target word across a message, and calculating a set distribution of the target word across the set of messages;
applying a machine learning algorithm to determine a message type prediction model based upon the calculated message distributions and set distributions;
obtaining a subject message, the subject message for a display caused by a subject software application;
utilizing the prediction model to identify the subject message as the first type message or the second type message; and
providing a communication identifying the subject message as the first type message or the second type message.
